(19) United States
(12) Patent Application Publication
(10) Pub. No.: US 2017/0278188 A1
(43) Pub. Date: Sep. 28, 2017

(54) PRE-CLEARANCE TRADING SYSTEM AND METHOD

(71) Applicants: Zachary Roeill, Marlboro, NJ (US); Vincent Framularo, Marlboro, NJ (US)

(72) Inventors: Zachary Roeill, Marlboro, NJ (US); Vincent Framularo, Marlboro, NJ (US)

(73) Assignee: Solution, LLC, Marlboro, NJ (US)

(21) Appl. No.: 15/469,345

(22) Filed: Mar. 24, 2017

Related U.S. Application Data
(60) Provisional application No. 62/312,888, filed on Mar. 24, 2016.

(51) Int. Cl. G06Q 40/04; G06Q 20/40

(52) U.S. Cl. CPC G06Q 40/04; G06Q 20/40

(57) ABSTRACT

A system and method for pre-clearing transactions comprising the steps of: creating and storing a client profile on a plurality of controllers; creating and storing a trading policy on the plurality of controllers; a pre-clearance client creating a client request; generating a decision request at the appropriate time, while verifying any applicable market conditions associated with the requested transaction only if the transaction requires specific market conditions to trigger execution; the plurality of controllers comparing the client request to the trading policy; the plurality of controllers rendering a pre-clearance decision and communicating pre-clearance decision details; the plurality of controllers issuing the client order to an active pre-clearing entity; and recording and storing all information.

### CROSS-REFERENCE TO RELATED APPLICATION(S)

The present application claims priority to U.S. Provisional Patent Application No. 62/312,888 filed on Mar. 24, 2016, entitled “PRE-CLEARANCE TRADING SYSTEM AND PROCESS” the entire disclosure of which is incorporated by reference herein.

### BACKGROUND OF THE INVENTION

1. Field of the Invention

The present disclosure relates to personal trading. More specifically, the present invention relates to the approval process before which personal securities transactions may be executed to ensure compliance with personal securities trading policy.

2. Description of Related Art

A wide variety of organizational institutions, e.g., listed or privately held corporations, businesses, municipalities, etc., enforce personal securities trading policies. These policies require the employees to obtain pre-clearance prior to engaging in personal securities transactions. Currently, the personal securities transaction pre-clearance process (hereinafter, the “pre-clearance process” or “pre-clearance”) requires an affiliated person to submit a series of elaborate manual requests prior to initiating a transaction at a broker-dealer such as a security purchase or sale. Once submitted by the affiliated person, the pre-clearance requests are internally reviewed at the organization. After a review, the organization (usually a compliance department) decides whether the requestor should be allowed to execute the requested trade. When pre-clearance is approved, the requesting party typically has window within which the transaction must be executed. If the transaction is not completed in that window of time, the transaction's pre-clearance expires and the pre-clearance approval process must be restarted. If affiliated personnel enter into personal security transactions without first receiving pre-clearance, he or she is subject to adverse consequences or discipline as outlined within the organizational institution's personal securities trading policies. These adverse consequences may lead to termination and, in some instances, criminal prosecution.

Due to the inherent volatility of financial securities markets and the general inability to predict market behaviors, the current personal transaction pre-clearance model impedes affiliated personnel from properly managing their portfolio and managing risks. For example, in the event that an affiliated person has not submitted a pre-clearance request and an unexpected drop in the market occurs, he or she will be unable to react to the sudden fluctuations in a timely manner, causing that individual to suffer financial harm that is otherwise avoidable, but-for the current pre-clearance process.

Based on the foregoing, there is a need in the art for an automated system that manages the personal transaction pre-clearance process from the request submission through the organizational institution's internal pre-clearance process, while communicating the information to all relevant parties at every step. Further, there is a need in the art to ensure affiliated personnel are able to engage in proper risk management while remaining compliant with personal securities trading policies. Additionally, there is a need in the art to facilitate proper risk management, optimize communications between all relevant market participants, and increase overall possible volume of personal transactions.

### SUMMARY OF THE INVENTION

The present disclosure relates to a system for pre-clearing transactions having one or more processors and one or more computer mediums, comprising code executable by the one or more processors for implementing a method for pre-clearing, comprising the steps of: receiving and storing a client profile on the non-transitory computer-readable storage medium from a client; receiving an order from a client; monitoring market conditions; generating and sending a pre-clearance request for evaluation by a requiring entity; and receiving a pre-clearance decision from the requiring entity. In one embodiment, the requiring entity comprises an entity having implemented restrictions on securities transactions by and between one or more parties. In another embodiment, the client comprises an person affiliated with the requiring entity in another embodiment, the order comprises a trade execution criteria comprising a type of security, a price limitation, or a date limitation; and wherein the pre-clearing entity comprises a broker or dealer.

In another exemplary embodiment of the present disclosure, a method of pre-clearing a transaction comprises the steps of receiving and storing a client profile from a client; receiving an order from a client comprising trade execution criteria; monitoring market conditions; generating and sending a pre-clearance request for evaluation by a requiring entity; and receiving a pre-clearance decision from the requiring entity. In one embodiment, the requiring entity comprises an entity having implemented restrictions on securities transactions by and between one or more parties. In another embodiment, the client comprises a person affiliated with the requiring entity. In another embodiment, the order comprises trade execution criteria comprising a type of security, a price limitation, or a date limitation. In another embodiment, the pre-clearing entity comprises a broker or dealer.

In another exemplary embodiment of the present disclosure, a method of pre-clearing a transaction by and between one or more parties comprises the steps of deriving a pre-clearance using parameters selected from the list consisting of specific trading instructions, a type of trading strategy associated with the transaction, a transaction identifier, and an account indicator of the one or more parties to the transaction; associating the pre-clearance with the transaction; reconciling, with the transaction, one or more corresponding transactions having one or more pre-existing account numbers, wherein the process of reconciling comprises a request selected from the group consisting of a request to assign, a request to match, and a request to enrich the pre-clearance to the one or more corresponding transactions; and issuing a pre-clearance authorization or a pre-clearance rejection.

The present disclosure enables affiliated personnel to maintain ongoing personal security transaction pre-clearances and provides a seamless transaction experience while ensuring compliance with personal security trading policies. The present disclosure facilitates the personal security transaction pre-clearance process enforced by organizational institutions such as businesses, municipalities, or other entity limiting securities transactions. Integrating the present disclosure into existing platforms at transactional organizations and organizational institutions solves the logistical problems faced by many. Such transactional organizations include brokers and dealers. The present disclosure expedites and streamlines the pre-clearance process by communicating and transferring the organizational institution's affiliated personnel's data to the Active Transaction Pre-Clearance System hub at the transactional organization, submitting personal security transaction pre-clearance request, validating personal security transaction details against policy at the organizational institution, communicating the transaction pre-clearance decision to the transactional organization, and ensuring proper data exchanges between participants at every step of the process.

In another exemplary embodiment of the present disclosure, a pre-clearance process is managed by ensuring any affiliated personnel satisfy the requisite restrictions implemented by organizational institutions prior to executing any securities transaction. Affiliated personnel comprise employees, contractors, or any other individual having trade restrictions. The affiliated personnel's ongoing pre-clearance is maintained through data transfers, validations, and communications between parties.

In an exemplary embodiment of the present disclosure, the system submits pre-clearance process requests in real-time. The system actively ensures that affiliated personnel obtain pre-clearance before executing personal security transactions in real-time. In another embodiment, transactions requiring specific market conditions are executed as those conditions are met. Examples of transactions requiring specific market conditions comprise good-til-cancelled orders, limit orders, and market orders.

In another exemplary embodiment of the present disclosure, the system manages the pre-clearance process by taking the personal securities trading policies of the organizational institution as an argument and comparing it against an affiliated personnel's transactions, including transactions requiring specific market conditions. The system issues a pre-clearance for the specified transaction if the trading policies are met. In one embodiment, the system performs the comparison on a preset interval. In another embodiment, the system performs the comparison every day before the applicable securities market opens.

In another exemplary embodiment, the Active Transaction Pre-Clearance System approves or denies pre-clearance of an organizational institution's affiliated personnel's personal security transaction by comparing the information of the affiliated personnel's personal security transaction against the personal security transaction restrictions set by the organizational institution.

In another exemplary embodiment of the present disclosure, the system submits an affiliated person's pre-clearance request as a market-triggered security transaction, occurring in real-time. In such an embodiment, a market-triggered transaction acts as the trigger for requesting pre-clearance for the transaction's execution, predefined by the affiliated person. In one embodiment, market-triggered security transactions comprise good-til-cancelled orders, limit orders, market orders, sell orders, and buy orders.

In another exemplary embodiment of the present disclosure, the system sends the request over one or more networks to the requiring entity. In one embodiment, the request is sent using a predetermined method of communication to a predetermined recipient wherein the recipient may approve or deny the request. In another embodiment, the system transmits the request over one or more networks to a controller having trading policies stored thereon. The system uses the stored policies to approve or deny the request.

In another exemplary embodiment of the present disclosure, a broker-dealer monitors market conditions in real time. Once the market conditions satisfy the affiliated person's market-triggering criteria, the system initiates a pre-clearance request. In another embodiment, the system initiates a pre-clearance request on a preset interval even if the market conditions are not met.

In another exemplary embodiment of the present disclosure, system alerts affiliated personnel of approvals and denials for personal security transaction pre-clearance.

In another exemplary embodiment of the present disclosure, the system stores the pre-clearance transaction details and requests pre-clearance from the organizational institution. In one embodiment, the pre-clearance transaction details comprise any market-based criteria for transaction execution, such as good-til-cancelled order timing. If the system approves the requested transaction, the system communicates the approval over one or more networks and the affiliated personnel are notified. If the transaction is denied, the system prevents the transaction from being executed and affiliated personnel are notified. In one embodiment, the system sends notifications over one or more networks. In another embodiment, the system sends notification using specified electronic communications. Electronic communications comprise email, text message, sms message, or fax.

In another exemplary embodiment of the present disclosure, the pre-clearance process is initiated at the personal account profile level via the transactional institution, e.g., a broker-dealer.

In another exemplary embodiment of the present disclosure, the system electronically transmits information between participants using one or more networks. Participants comprise transactional institutions, organizational institution, affiliated personnel, or controllers.

The foregoing, as well as other features and advantages of the present invention disclosed herein, will be apparent from the following particular descriptions of the preferred embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1 is a flowchart diagram detailing the pre-clearance trading system, according to an embodiment of the present disclosure.

FIG. 2 is a flowchart diagram detailing the pre-clearance trading system, according to an embodiment of the present disclosure.

### DETAILED DESCRIPTION OF PREFERRED EMBODIMENTS

The following is a glossary of terms with acronyms as used and contained herein:

Pre-clearing Entity—an exemplary broker or dealer utilizing the pre-clearance system disclosed herein;

Requiring Entity—an exemplary employer, contracting firm, institution or entity with pre-clearance policies utilizing the pre-clearance system disclosed herein;

Application Program Interface (“API”)—an exemplary set of routines, protocols, and tools specifying how software components interact as disclosed herein;

Pre-clearance Management Software (“PMS”)—an exemplary Application Program Interface held at the Active Pre-clearing Entity, according to an exemplary embodiment of the present disclosure;

Active Pre-clearing Software (“APS”)—an exemplary Application Program Interface held at the Pre-clearance Requiring Entity; serves as an institutional database for validation purposes, according to an exemplary embodiment of the present disclosure;

Client—an exemplary client, employee, or account holder required by the Pre-clearance Requiring Entity to pre-clear personal transactions;

Client Profile—an exemplary profile created by the Pre-clearance Client comprising information relevant to trading;

Pre-clearance Decision (“PCD”)—The decision made at the Pre-clearance Requiring Entity on whether to approve or deny transaction pre-clearance;

Trade Execution Criteria (“TEC”)—exemplary criteria set by the Pre-clearance Client that instructs the Active Pre-clearing Entity on when to request validation from the Pre-clearance Requiring Entity;

Electronic Data Exchange (“EDI”)—an exemplary transfer or communication of information from one party to another, according to an embodiment of the present disclosure;

Personal Trading Policies (“PTP”)—exemplary policies at the institution, firm, or entity that requires transaction pre-clearance, according to an embodiment of the present disclosure;

Pre-clearance Data (“PD”)—exemplary personal and account information of the Pre-clearance Client held by the Active Pre-clearing Entity;

Pre-clearance Request (“PCR”)—a request generated by the system when the Client's Trade Execution Criteria are met, and transmitted to the Requiring Entity;

Market Conditions—any factors that influence the buying and selling patterns of market participants comprising general market trends, security process, and pre-clearance approval status;

Security—an exemplary instrument that has an issuer and/or where the price of that instrument changes throughout the day and/or can be executed on any of those prices, examples include stocks, corporate bonds, derivatives, quasi-government agencies, private security holdings, closed end and exchange traded funds, exchange traded notes and proprietary open end funds; and

Security Transaction—an exemplary transaction involving a security.

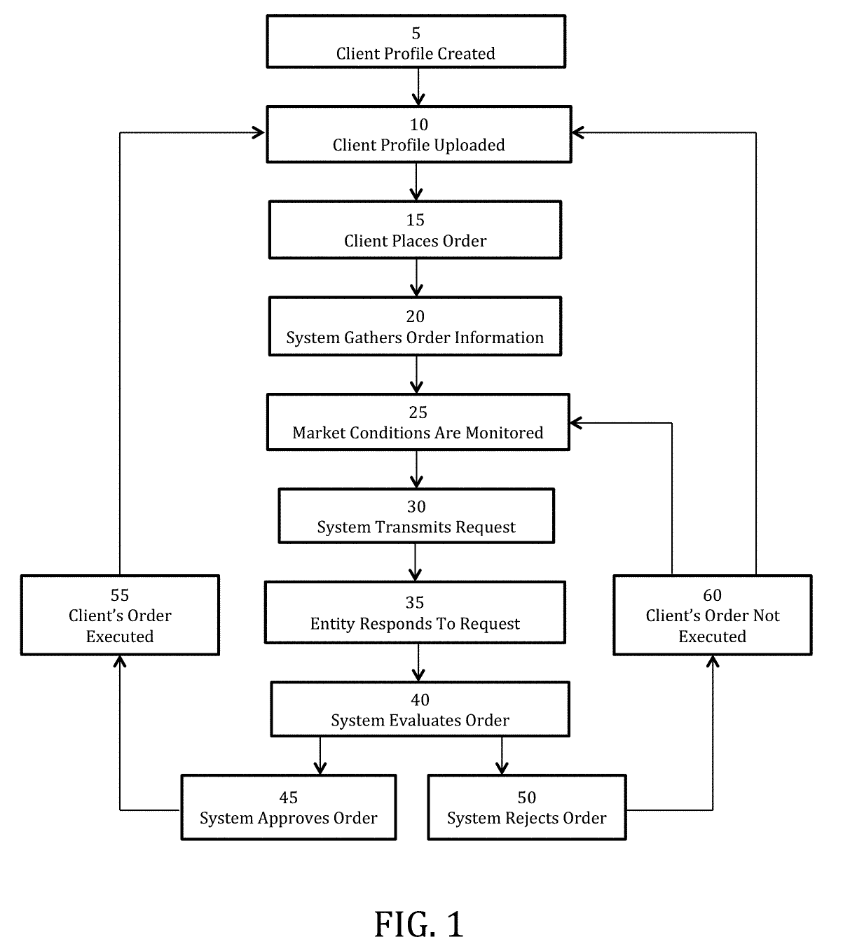

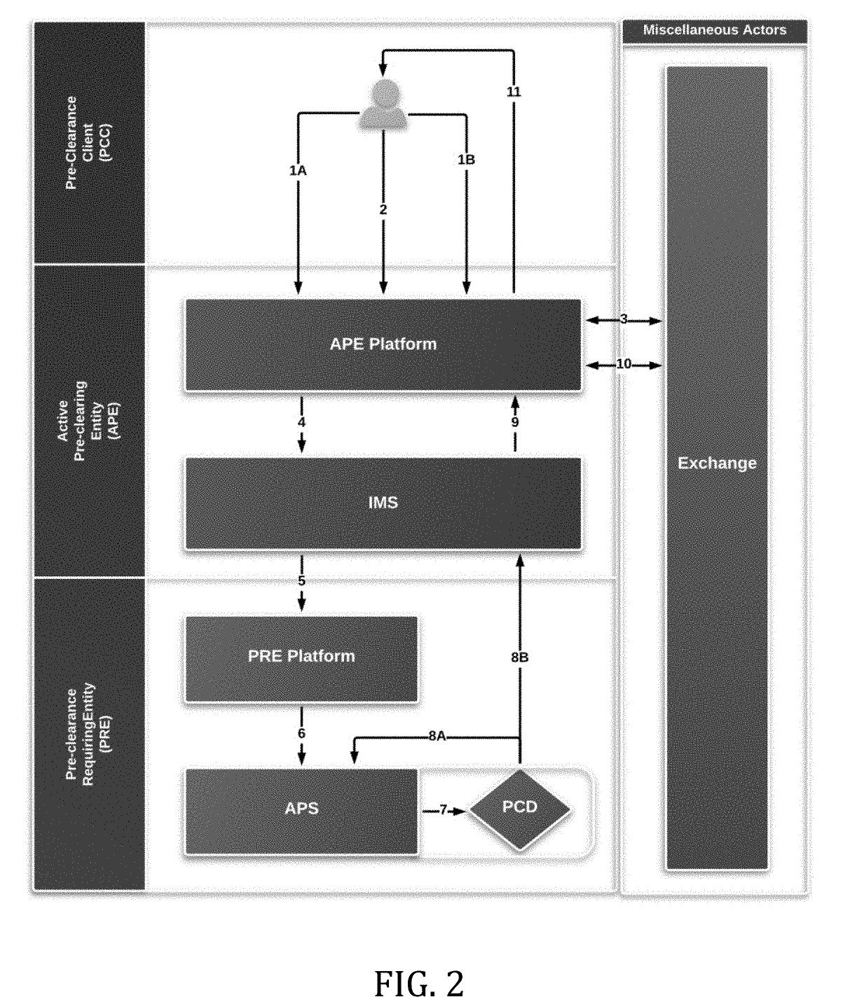

Preferred embodiments of the present invention and their advantages may be understood by referring to FIGS. 1-2.

In an exemplary embodiment of the present disclosure, the Client creates a Client Profile that is stored by the system. In one embodiment, the Client Profile comprises relevant trading information that may include association with a Requiring Entity, information related to securities owned by the Client, information related to securities in which the Client has an interest, or Personal Trading Policies.

In another exemplary embodiment of the present disclosure, the Requiring Entity creates a Requiring Entity Profile that is stored on the system. In one embodiment, the Requiring Entity Profile comprises Personal Trading Policies.

In another exemplary embodiment of the present disclosure, the Pre-clearing Entity creates an Entity Profile that is stored on the system. In one embodiment, the Entity Profile comprises the Personal Trading Policies or the Client Profile.

In an exemplary embodiment of the present disclosure, a Client engages in trading securities using an Pre-clearing Entity. In some instances, the Client must obtain permission from a Requiring Entity before executing a trade. In one embodiment, the Client creates and delivers Trade Execution Criteria to the Pre-clearing Entity. The Pre-clearing Entity monitors market conditions. When the Client's Trade Execution Criteria are satisfied, the system transmits the Pre-clearance Data to the Requiring Entity. In one embodiment, the system generates a Pre-clearance Decision by evaluating the Pre-clearance Data against the Personal Trading Policies. In another embodiment, the system compiles and delivers the Pre-clearance Data to a compliance officer at the Requiring Entity. The compliance officer may generate the Pre-clearance Decision. The system transmits the Pre-clearance Decision to the Pre-clearing Entity. If the Requiring Entity approved Trade Execution Criteria, the Pre-clearing Entity performs the trade in accordance with Trade Execution Criteria. If the Requiring Entity rejected the Trade Execution Criteria, the Pre-clearing Entity does not perform the trade. In one embodiment, the system records and stores the Trade Execution Criteria, the Pre-clearance Data, or the Personal Trading Policies. In another embodiment, the system transmits a trade notification to the Pre-clearing Entity, the Requiring Entity, or the Client. In one embodiment, the trade notification comprises the Pre-clearance Data, the Personal Trading Policies, the Trade Execution Criteria, or the Pre-clearance Decision.

In another exemplary embodiment of the present disclosure, the system records and stores all electronic data exchanged using the Pre-clearance Management Software and the Active Pre-clearing Software in real-time.

In another exemplary embodiment of the present disclosure, the system stores validation results for record keeping purposes, transmits notifications of transaction compliance, and transmits updates through their respective interfaces to transaction participants. In one embodiment, the system transmits over one or more wired or wireless networks.

In another exemplary embodiment of the present disclosure, the Requiring Entity updates the Personal Trading Policies stored on the system. In another embodiment, the Client updates the Client Profile stored on the system.

In another exemplary embodiment of the present disclosure, the system generates a Pre-clearance Request when the Trade Execution Criteria is met. In one embodiment, the system transmits the Pre-clearance Request to the Requiring Entity over one or more wired or wireless networks. In another embodiment, the Pre-clearance Request comprises the Trade Execution Criteria, the Client Profile, or the Pre-clearance Data. In another embodiment, the system generates and transmits the Pre-clearance Request as determined by the Pre-clearing Entity. In another embodiment, the system generates and transmits the Pre-clearance Request on a predetermined schedule, e.g., every morning at market open.

In another exemplary embodiment of the present disclosure, the system synchronizes the Pre-clearance Management Software with the Client Profile. In another embodiment, the system synchronizes the Client Profile if the Client is affiliated with a Requiring Entity and the Client enables active pre-clearing on a Pre-Clearing Entity's system. In another embodiment, the system submits Pre-clearance Request when the Trade Execution Criteria is met to the APS at the Requiring Entity. In another embodiment, the system compiles the Pre-clearance Decision result and takes appropriate action, e.g., executing the transaction or not executing the transaction.

In another exemplary embodiment of the present disclosure, the system performs actions though the Active Pre-clearing Software. In one embodiment, the system stores data relating to the Requiring Entity's Personal Trading Policies. In another embodiment, the system compares the Client's personal transaction data comprising Pre-clearance Data against the Personal Trading Policies stored on the system in generating the Pre-clearance Decision. In another embodiment, the system transmits the Pre-clearance Decision to the Pre-clearance Management Software.

In an exemplary embodiment of the present disclosure, a Pre-clearance Client cannot engage in a securities transaction unless that specific transaction is approved by the Pre-clearance Requiring Entity. In one embodiment, the Pre-clearance Requiring Entity may manually approve or reject the transaction proposed in the Pre-clearance Request.

In another exemplary embodiment of the present disclosure, the Pre-clearance system comprises one or more transmitters that are configured to send information over one or more wired or wireless networks.

In another exemplary embodiment of the present disclosure, the Pre-clearance system comprises one or more receivers that are configured to receive information from one or more wired or wireless networks.

In another exemplary embodiment of the present disclosure and with reference to FIG. 1, in step 5, a Client creates a Client Profile. Additionally, the Requiring Entity also creates a profile comprising the Personal Trading Policies. In one embodiment, the Requiring Entity comprises an employer, a contracting firm, or any other entity having pre-clearance policies. In another embodiment, the Requiring Entity specifies Personal Trading Policies comprising specific personal securities trading policies and procedures. In another embodiment, the system stores the Client Profile information on a plurality of controllers. In another embodiment, the system stores the Requiring Entity's information on the plurality of controllers. In one embodiment, the plurality of controllers comprises one or more data storage devices. In another embodiment, the plurality of controllers comprises one or more processors configured to execute mathematical algorithms. In another embodiment, the plurality of controllers is configured to transmit and receive data over one or more wired or wireless networks. In another embodiment, one or more of the plurality of controllers may be stored remotely, at the Requiring Entity, at the Pre-clearing Entity, or at the Client's location.

In another exemplary embodiment of the present disclosure and with reference to FIG. 1, in step 10, Client Profile is updated. In one embodiment, the system automatically updates the Requiring Entity's Personal Trading Policies. In another embodiment, the Client updates the Client Profile. In another embodiment, the Pre-clearance Requiring Entity's specific personal securities trading policies and procedures are updated by the Pre-clearance Requiring Entity.

In another exemplary embodiment of the present disclosure and with reference to FIG. 1, in step 15, the Client places an order to transact. In one embodiment, the Client may place the order using the Application Program Interface. In another embodiment, the client places the order with the Pre-clearing Entity. In one embodiment, the Client specifies the Trade Execution Criteria. In another embodiment, the system transmits the order to the Pre-clearing Entity. In another embodiment, the Client may place an order directly with the Requiring Entity wherein the order is approved or denied by the Requiring Entity. In such an embodiment, the order is transmitted to the Pre-clearing Entity if approved by the Requiring Entity. In another embodiment, the Requiring Entity monitors market conditions and issues the preclearance without the Client making any request to the Pre-clearing Entity such that that Pre-clearing Entity is only notified of transactions that have been pre-approved by the Requiring Entity.

In another exemplary embodiment of the present disclosure and with reference to FIG. 1, in step 20, the system gathers the order information. In one embodiment, the system gathers the Trade Execution Criteria specified by the Client. In another embodiment, the system gathers relevant trade information from the Requiring Entity. In another embodiment, the system gathers any Client updates, requested personal security transaction data, the latest market conditions from the Pre-clearing Entity, and all electronic data including exchange acknowledgments. In one embodiment, the electronic data exchange acknowledgments includes the time stamp of the Client's request, the number and type of security in the Trade Execution Criteria, and the sale price.

In another exemplary embodiment of the present disclosure and with reference to FIG. 1, in step 25, the system monitors market activity. In one embodiment, the system monitors markets specified by the Client. In another embodiment, the system sends a request for an update to a third party on a specified interval, to which the third party responds with the market conditions pertaining to the specified parameters. In another embodiment, the system transmits the Trade Execution Criteria to the Pre-clearing Entity. The Pre-clearing Entity monitors the relevant market for the conditions delineated in the Trade Execution Criteria.

In another exemplary embodiment of the present disclosure and with reference to FIG. 1, in step 30, the system generates and transmits a Pre-clearance Request. In one embodiment, the system monitors markets. When the Trade Execution Criteria specified by the Client are met, the system generates and transmits the Pre-clearance Request to the Requiring Entity. In one embodiment, the system compiles the account and profile information, which is sent to the Requiring Entity along with the Trade Execution Criteria. In another embodiment, the Pre-clearing Entity monitors markets and generates a Pre-clearance Request when the Trade Execution Criteria is satisfied. In another embodiment, the system generates and transmits the Pre-clearance Request on a predetermined interval. In another embodiment, the system generates and transmits the Pre-clearance Request on a predetermined interval as long as the Trade Execution Criteria order has not been satisfied. In another embodiment, the system transmits the Pre-clearance Request over one or more wired or wireless networks. In another embodiment, the system records and stores all relevant information including the time, date, specific criteria, market conditions and number of securities involved on the plurality of controllers. In another embodiment, the Pre-clearance request comprises an enriched Client Order wherein the system augments the Order with pre-determined information.

In another exemplary embodiment of the present disclosure and with reference to FIG. 1, in step 35, the system responds to the Pre-clearance Request once received by the Requiring Entity. In one embodiment, the system compiles the relevant information including the specified market conditions, the trade criteria, the account, the profile, and the updated policies as specified by the Requiring Entity. In another embodiment, the system compiles and delivers all relevant information to a compliance officer at the Requiring Entity. The compliance officer may respond to the Pre-clearance Request.

In another exemplary embodiment of the present disclosure and with reference to FIG. 1, in step 40, the system evaluates the Pre-clearance Request. In one embodiment, the system takes the Requiring Entity's policies and the Trade Execution Criteria as arguments. The system compares the arguments against the Trade Execution Criteria and the market conditions specified in the Pre-clearance Request. In another embodiment, the system compares the Personal Trading Policies and procedures against the Trade Execution Criteria specified by the Pre-clearance Client. In another embodiment, the system compiles a provides the Trade Execution Criteria, the Personal Trading Policies, the Pre-clearance Data, and the Pre-clearance Request to a compliance officer at the Requiring Entity. The compliance officer may approve or deny the Pre-clearance Request. In one embodiment, the compliance officer may override a previously generated Pre-clearance Request.

In another exemplary embodiment of the present disclosure and with reference to FIG. 1, in step 45, the system approves transaction pre-clearance if the submitted transaction details do not violate the Requiring Entity's Personal Trading Policies. In another embodiment, the system validates the Pre-clearance Approval a predetermined number of times before the system generates the Pre-clearance Decision. In another embodiment, the system records and stores all information used in evaluating the order and the system's approval including the time stamp, stock quantity, time, and date. In another embodiment, the system sends all information relevant to the evaluation to a predetermined list of recipients. In another embodiment, a compliance officer at the Requiring Entity approves the Pre-clearance Request. In another embodiment, the compliance officer may override Pre-clearance Decision. In another embodiment, the approval comprises an enriched Request wherein the system augments the request with predetermined parameters.

In another exemplary embodiment of the present disclosure and with reference to FIG. 1, in step 50, the system rejects the order if the Trade Execution Criteria violate or contradict the Requiring Entity's Personal Trading Policies. In one embodiment, the system stores all information relevant to the transaction including the time stamp, stock quantity, time, and date. In another embodiment, a compliance officer at the Requiring Entity may override the system's rejection.

In another exemplary embodiment of the present disclosure and with reference to FIG. 1, in step 55, the system executes the Client's order. In one embodiment, system sends the Client's order to an Pre-clearing Entity. The Pre-clearing Entity executes the order as specified by the Trade Execution Criteria. In one embodiment, the Pre-clearing Entity comprises a personal securities broker or dealer. In another embodiment, the system generates the Pre-clearance Decision. In one embodiment, the Pre-clearance Decision comprises the Trade Execution Criteria, the Client Profile, the Pre-clearance Request, and the Pre-clearance Data. The Pre-clearing Entity executes the order specified in the Trade Execution Criteria. In another embodiment, if the market conditions change so that the Trade Execution Criteria is no longer met, the order will not be executed. In another embodiment, the system records and stores all relevant information including the time, date, market conditions, and under what conditions the Pre-clearing Entity executed the order. In another embodiment, the system updates the Pre-clearance Client's account and profile based on the executed order.

In another exemplary embodiment of the present disclosure and with reference to FIG. 1, in step 60, the system prevents the Client's order from being executed. In one embodiment, the system does not allow the Client to communicate with the Pre-clearing Entity. In another embodiment, the system records and stores all relevant information. In another embodiment, the system updates the Client Profile. In another embodiment, the system returns to step 25, wherein the system resumes monitoring the marked conditions. In another embodiment, the system transmits the Pre-clearance Decision to the Pre-clearing Entity wherein the Pre-clearing Entity is instructed to not execute the transaction.

In another exemplary embodiment of the present disclosure and with reference to FIG. 2, in steps 1A and 1B, the Client Profile is created or updated through the existing Pre-clearing Entity's platform. The Client Profile is onboarded to the Pre-clearance Management Software.

In another exemplary embodiment of the present disclosure and with reference to FIG. 2, in step 2, the Client determines and defines the Trade Execution Criteria within the system using the Pre-clearing Entity's platform, i.e., the Client places an order on the broker system.

In another exemplary embodiment of the present disclosure and with reference to FIG. 2, in step 3, the Trade Execution Criteria are continuously checked against market.

In another exemplary embodiment of the present disclosure and with reference to FIG. 2, in step 4, the Pre-clearance Management Software pulls static Client data updates, requested Pre-clearance Data, the latest market conditions from the existing Pre-clearing Entity's platform, and all Electronic Data Exchange acknowledgments, including all relevant information, are stored in the system using the Pre-clearance Management Software.

In another exemplary embodiment of the present disclosure and with reference to FIG. 2, in step 5, when the Trade Execution Criteria is met, the Pre-clearance Management Software sends the Pre-clearance Request to the Active Pre-clearing Software at the Requiring Entity, and the Electronic Data Exchange acknowledgment is stored in the system using the Pre-clearance Management Software.

In another exemplary embodiment of the present disclosure and with reference to FIG. 2, in step 6, the system transmits data from the Requiring Entity's platform to the Active Pre-clearing Software.

In another exemplary embodiment of the present disclosure and with reference to FIG. 2, in step 7, the system evaluates the trade using Active Pre-clearing Software. The Active Pre-clearing Software comprises a plurality of algorithms configured to perform predetermined evaluations comprising a decision on the Pre-clearance Request, wherein the Pre-clearance Data is matched against the Requiring Entity's Personal Trading Policy data stored in a plurality of controllers.

In another exemplary embodiment of the present disclosure and with reference to FIG. 2, in steps 8A and 8B, the system generates the Pre-clearance Decision. In another embodiment, the system stores the Pre-clearance Decision in the plurality of controllers. In another embodiment, the Pre-clearance Decision is transmitted to the Pre-clearance Management Software at the Pre-clearing Entity. In one embodiment, the Pre-clearance Decision comprises all relevant information of the transaction including a time stamp, stock quantity, stock type, and stock price. In another embodiment, the system generates the Pre-clearance Decision by evaluating whether the Pre-clearance Data meets the Personal Trading Policies. The system approves the Pre-clearance Decision if the Personal Trading Policies are met. The system denies the Pre-clearance Decision if the Personal Trading Policies are not met.

In another exemplary embodiment of the present disclosure and with reference to FIG. 2, in step 9, the system provides the Pre-clearing Entity's order platform with the personal security transaction pre-clearance approval using the Pre-clearance Management Software.

In another exemplary embodiment of the present disclosure and with reference to FIG. 2, in step 10, the Pre-clearing Entity takes action in accordance with the Pre-Clearance Decision from the Requiring Entity. In one embodiment, the system utilizes algorithms configured to compare the rules and algorithms stored within the plurality of controllers and Active Pre-clearance Software in evaluating Pre-clearance Request. If the system approves the Pre-clearance Request, the Client's transaction is executed. If the system denies the Pre-clearance Request, the Client's transaction is cancelled. The Client is notified of the execution or cancellation.

In another exemplary embodiment of the present disclosure and with reference to FIG. 2, in step 11, the Client is notified of the transaction's status.

Hereinafter, general aspects of implementation of the systems and methods of the invention will be described.

The system of the invention or portions of the system of the invention may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device (“PLD”) such as a Field-Programmable Gate Array (“FPGA”), Programmable Logic Array (“PLA”), or Programmable Array Logic (“PAL”), or any other device or arrangement of devices that is capable of implementing the steps of the processes of the invention.

The processing machine used to implement the invention may utilize a suitable operating system. Thus, embodiments of the invention may include a processing machine running the iOS operating system, the OS X operating system, the Android operating system, the Microsoft Windows™ 8 operating system, Microsoft Windows™ 7 operating system, the Microsoft Windows™ Vista™ operating system, the Microsoft Windows™ XP™ operating system, the Microsoft Windows™ NT™ operating system, the Windows™ 2000 operating system, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, the Apache operating system, an OpenStep™ operating system or another operating system or platform.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity, i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention. The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

I claim:

1. A computer-readable, non-transitory programmable product, for implementing pre-clearance of a transaction, comprising code executable by one or more processors, to cause the one or more processors to do the following:
i. input client profile information in a memory;
ii. monitor, with the one or more processors, market conditions for predetermined criteria in connection with the client profile information and receipt of market data;
iii. generate a pre-clearance request for evaluation by a requiring entity in connection with receipt of an order and detection of the predetermined criteria; and
iv. cause the execution of a transaction decision in connection with receipt of a pre-clearance decision.

2. The computer-readable, non-transitory programmable product as recited in claim 1 wherein the request comprises:
a. iteratively comparing the trade execution criteria against market conditions;
b. generating a pre-clearance request if market conditions meet the trade execution criteria; and
c. transmitting the pre-clearance request to the requiring entity.

3. The system of claim 1, wherein the method for pre-clearing comprises the step of recording transaction details on the one or more non-transitory computer-readable storage mediums.

4. A method of pre-clearing a transaction using a processor comprising:
a. receiving and storing client profile information in a database;
b. receiving an order comprising trade execution criteria;
c. monitoring market conditions which meet the trade execution criteria;
d. generating and sending, for evaluation by a requiring entity, a pre-clearance request in connection with detecting the trade execution criteria; and
e. receiving a pre-clearance decision from the requiring entity.

5. The method of claim 4, wherein generating and sending a pre-clearance request further comprises the steps of:
a. iteratively comparing the trade execution criteria against market conditions;
b. generating a pre-clearance request if the market conditions meet the trade execution criteria; and
c. transmitting the pre-clearance request to the requiring entity.

6. The method of claim 4, wherein the method for pre-clearing comprises the step of recording transaction details on one or more storage mediums.

7. The method of claim 4 further comprising the step of executing a transaction based on the pre-clearance decision.

8. A method of pre-clearing a transaction using a processor by and between one or more parties comprising the steps of:
a. deriving a pre-clearance procedure using parameters selected from the list in a database consisting of specific trading instructions, a type of trading strategy associated with the transaction, a transaction identifier, an account indicator of the one or more parties to the transaction, and a combination thereof;
b. associating the pre-clearance procedure with the transaction;
c. reconciling, with the transaction, one or more corresponding transactions having one or more pre-existing account numbers, wherein the process of reconciling comprises a request selected from the group consisting of a request to assign, a request to match, and a request to enrich the pre-clearance procedure to the one or more corresponding transactions; and
d. transmitting a pre-clearance authorization or a pre-clearance rejection.

9. The method of claim 8, further comprising the step of sending one or more transmission to the one or more parties, wherein the one or more transmissions includes the pre-clearance authorization or the pre-clearance rejection.

10. The method of claim 8, wherein the pre-clearance is associated using unique criteria provided by one or more of the one or more parties.

11. The method of claim 8 further comprising the step of receiving a request from the one or more parties to the one or more transactions, wherein the request is formed in a separate transmission including the one or more pre-clearance requests, and wherein the one or more pre-clearance requests are used to match the request with the account identifier for the one or more transactions.

12. The method of claim 11, further comprising the step of receiving a request from the one or more parties to the transaction, wherein the request is formed in a separate transmission including one or more different pre-clearance requests for the transaction or a plurality of transactions, wherein one or more of the one or more parties have the ability to determine which pre-clearance request becomes associated with, and assigned to, the respective transaction or one or more transactions.

13. The method of claim 9, further comprising the step of receiving a request from the one or more parties to the one or more transactions, wherein the request is formed in a separate transmission including one or more different pre-clearance requests for the same transaction or plurality of transactions, wherein a pre-clearance system determines whether the pre-clearance is received and communicates the pre-clearance authorization or rejection.

14. A method of facilitating or receiving a pre-clearance using a processor comprising the steps of:
a. receiving a request for one or more pre-clearance authorizations from one or more parties to one or more transactions, wherein an identifier is associated with the one or more transactions;
b. deriving the pre-clearance authorization, wherein each pre-clearance authorization is unique, and wherein the process of deriving the one or more pre-clearance authorizations ensures association with the one or more parties;
c. associating the one or more pre-clearance authorizations with the one or more transactions, where pre-clearance approval allows for the transaction's execution and pre-clearance rejection does not allow for the transaction's execution;
d. sending one or more transmissions to the one or more parties, wherein the one or more transmissions include the one or more transactions and the one or more pre-clearance authorizations; and
e. receiving a request to issue the pre-clearance for the one or more transactions so that one or more final transactions corresponding to the one or more transactions can be transmitted to the one or more parties, wherein the one or more final transactions include the one or more pre-clearance authorizations, and wherein the request is selected from the group consisting of a request to assign, a request to match, and a request to enrich the one or more pre-clearances to the one or more transactions.
